(19) United States
(12) Patent Application Publication
(10) Pub. No.: US 2008/0316252 A1
(43) Pub. Date: Dec. 25, 2008

(54) INK-JET IMAGE FORMING APPARATUS

(75) Inventors: Gu Hwan NA, Seoul (KR); Heon Soo Park, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/056,460

(22) Filed: Mar. 27, 2008

(30) Foreign Application Priority Data
Jun. 21, 2007 (KR) 2007-61068

(51) Int. Cl. B41J 2/165

(52) U.S. Cl. 347/33; 347/22

(57) ABSTRACT

An ink-jet image forming apparatus includes a main body, an ink-jet head mounted in the main body and provided with a nozzle part, and a cleaning device mounted movably along the nozzle part to clean the nozzle part. The cleaning device includes a roller to supply a cleaning liquid to the nozzle part, and a wiper to wipe the nozzle part. The ink-jet head includes a cleaning liquid nozzle to supply the cleaning liquid to the roller, and a cleaning liquid storage part to store the cleaning liquid.

### CROSS-REFERENCE TO RELATED APPLICATIONS

This application claims priority under 35 U.S.C. §119(a) from Korean Patent Application No. 2007-0061068, filed on Jun. 21, 2007 in the Korean Intellectual Property Office, the disclosure of which is incorporated herein in its entirety by reference.

### BACKGROUND OF THE INVENTION

1. Field of the Invention

The present general inventive concept relates to an ink-jet image forming apparatus, and more particularly, to an ink-jet image forming apparatus having a cleaning device to clean a nozzle part

2. Description of the Related Art

An ink-jet image forming apparatus is an apparatus that forms an image by ejecting an ink onto a recording medium through a nozzle part of an ink-jet head. An ink drop, which is not ejected, remains on the nozzle part of the ink-jet head. If the nozzle part is exposed to air, the residual ink drop on the nozzle part may be solidified, or a foreign substance such as a dust in the air may be attached to the ink drop.

The hardened ink or the foreign substance attached to the nozzle part prohibits the ink ejection in an exact direction, causing the deterioration of a printing quality, and even chokes the nozzle. Thus, the ink-jet image forming apparatus is necessarily provided with a cleaning device to remove the foreign substance from the nozzle part. There is a known method for cleaning the nozzle part using a cleaning device with a wiper to wipe off the hardened ink or the foreign substance from the nozzle part. However, such a conventional cleaning method has a limitation in removing the hardened ink or the foreign substance from the nozzle part. Recently, a wet cleaning method has been used to remove the hardened ink or the foreign substance from the nozzle part by wetting the surface of the nozzle part with a cleaning liquid.

U.S. Pat. No. 6,281,909 discloses a cleaning device which cleans a nozzle part of an ink-jet head by a wet cleaning method. The disclosed cleaning device includes a container which is disposed below a nozzle part of an ink-jet head and contains a cleaning liquid, and a cleaning roller which rotates while being partially immersed in the cleaning liquid in the container. The cleaning device cleans the nozzle surface in such a manner that the cleaning roller wet with the cleaning liquid rubs the nozzle surface with the cleaning liquid.

However, the ink-jet image forming apparatus having the above cleaning device has a problem of a complicated constitution, because the container storing the cleaning liquid should be disposed below the nozzle part of the ink-jet head and additional supply means (a pump, a cleaning liquid supply passage, an additional cleaning liquid container, etc.) to supply the cleaning liquid into the container should be provided. Also, the conventional cleaning device has a problem of a large consumption of the cleaning liquid

### SUMMARY OF THE INVENTION

The present general inventive concept provides an ink-jet image forming apparatus that has a cleaning device capable of simplifying a cleaning liquid supply unit and reducing the consumption of a cleaning liquid.

The present general inventive concept also provides an ink-jet image forming apparatus that has a cleaning device capable of minimizing contamination of a nozzle part due to a roller.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink-jet image forming apparatus including a main body, an ink-jet head mounted in the main body and provided with a nozzle part, and a cleaning device movably mounted along the nozzle part to clean the nozzle part. The cleaning device includes a roller to supply a cleaning liquid to the nozzle part, and a wiper to wipe the nozzle part. The ink-jet head includes a cleaning liquid nozzle to supply the cleaning liquid to the roller, and a cleaning liquid storage part to store the cleaning liquid.

The cleaning liquid nozzle and the cleaning liquid storage part may be integrally provided in the ink-jet head.

The nozzle part may have a length in a main scanning direction corresponding to a width of paper. The cleaning device may include a moving member to support the roller and the wiper and to move in a longitudinal direction of the nozzle part, a guide member to guide the movement of the moving member, and a driving device to move the moving member.

The cleaning liquid nozzle may be disposed near one end of the nozzle part. During a non-cleaning state, the moving member may move to a stop position adjacent to the cleaning liquid nozzle so that the roller is located corresponding to the cleaning liquid nozzle.

The cleaning device may include a rotating member rotatably coupled to the moving member and provided with a plurality of roller supporting portions. The roller may be a plurality of rollers, and the rollers may be respectively mounted to the roller supporting portions. The wiper may be a plurality of wipers, and the wipers may be respectively mounted to the roller supporting portions.

The cleaning device may include a one-direction rotating device which limits the rotation of the rotating member when the moving member moves in a cleaning direction from the stop position, and allows the rotation of the rotating member when the moving member returns to the stop position.

The cleaning device may include a latching device provided at the stop position. When the moving member returns to the stop position, the rotating member may be latched by the latching device, and may rotate at a predetermined angle.

The one-direction rotating device may include a ratchet provided at the rotating member, a stopper latched by the ratchet, and a spring to bias the stopper toward the ratchet.

The driving device may include a driving motor, and a driving belt which travels in a forward direction and in a reverse direction by the operation of the driving motor and moves the moving member in a cleaning direction and in a return direction.

The roller may have a surface made of a porous absorbing material.

The foregoing and/or other aspects and utilities of the present general inventive concept may also be achieved by providing an ink-jet image forming apparatus including an ink-jet head provided with a nozzle part, and a cleaning device mounted movably along the nozzle part to clean the nozzle part. The ink-jet head includes a cleaning liquid nozzle to supply a cleaning liquid to the cleaning device, and a cleaning liquid storage part to store the cleaning liquid.

The foregoing and/or other aspects and utilities of the present general inventive concept may also be achieved by providing an ink-jet image forming apparatus including an ink-jet head provided with a nozzle part having a length in a main scanning direction corresponding to a width of paper, and a cleaning device movably mounted along the nozzle part to clean the nozzle part. The cleaning device includes a moving member to move in a longitudinal direction of the nozzle part, a guide member to guide the movement of the moving member, a driving device to move the moving member, a rotating member rotatably coupled to the moving member and provided with a plurality of roller supporting portions, a plurality of rollers respectively mounted to the roller supporting portions to supply a cleaning liquid to the nozzle part, a plurality of wipers respectively mounted to the roller supporting portions, and a one-direction rotating device which limits the rotation of the rotating member when the moving member moves in a cleaning direction and allows the rotation of the rotating member at a predetermined angle when the moving member.

The foregoing and/or other aspects and utilities of the present general inventive concept may also be achieved by providing an image forming apparatus including an ink-jet head having an ink storage part to store ink to be ejected, and a cleaning liquid storage part to store a cleaning liquid to be used to clean the ink-jet head.

The nozzle part and the cleaning part may be formed in a single integrated body.

The image forming apparatus may further include a cleaning device to receive the cleaning liquid from the cleaning liquid storage and to clean the ink-jet head.

The ink-jet head may include a nozzle part to eject the ink of the ink storage part, and a cleaning liquid nozzle to eject the cleaning liquid.

The foregoing and/or other aspects and utilities of the present general inventive concept may also be achieved by providing an image forming apparatus including an ink-jet head having a nozzle part to eject ink, and a cleaning nozzle part to eject a cleaning liquid to clean the nozzle part.

The nozzle part may eject the ink in a printing operation, and the cleaning nozzle part may eject the cleaning liquid in a maintenance operation.

The nozzle part and the cleaning part may be formed in a single integrated body.

The ink-jet head may include an ink storage part to store the ink to be used to form an image on a medium, and a cleaning liquid storage part to store the cleaning liquid to be used to clean the ink-jet head.

The image forming apparatus may further include a cleaning device disposed to have a first distance with the nozzle part in a printing operation and to have a second distance with the nozzle part in a return operation.

The foregoing and/or other aspects and utilities of the present general inventive concept may also be achieved by providing an image forming apparatus including an ink-jet head having a nozzle unit to exclusively eject ink in a printing operation and eject a cleaning liquid in a maintenance operation.

The foregoing and/or other aspects and utilities of the present general inventive concept may also be achieved by providing an image forming apparatus including an ink-jet head having a storage unit to store ink and cleaning liquid, and a nozzle unit to exclusively eject one of the ink and the cleaning liquid.

The foregoing and/or other aspects and utilities of the present general inventive concept may also be achieved by providing an image forming apparatus including a feeding unit to feed a medium; and an ink-jet head having an ink storage part to store ink, a nozzle part formed on the ink storage part to eject the stored ink, a cleaning liquid storage part to store a cleaning liquid, and a cleaning liquid nozzle part formed on the cleaning liquid storage part to eject the stored cleaning liquid to be used to clean the nozzle part.

The foregoing and/or other aspects and utilities of the present general inventive concept may also be achieved by providing a method of an image forming apparatus, the method including providing in a single integrated body an ink-jet head having an ink storage part to store ink, and a cleaning liquid storage part to store a cleaning liquid, ejecting the ink in a printing operation, and ejecting the cleaning liquid in a maintenance operation to clean the ink-jet head.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which

FIG. 1 is a view illustrating an ink-jet image forming apparatus according to an exemplary embodiment of the present general inventive concept;

FIG. 2 is a perspective view illustrating an ink-jet head and a cleaning device of the ink-jet image forming apparatus of FIG. 1 according to an exemplary embodiment of the present general inventive concept;

FIG. 3 is a sectional view illustrating the cleaning device of FIG. 2;

FIG. 4 is a perspective view illustrating a rotating member and a one-direction rotating device when a moving member moves in a cleaning direction;

FIG. 5 is a sectional view illustrating the cleaning device of FIG. 2 when the moving member moves in the cleaning direction;

FIG. 6 is a sectional view illustrating the cleaning device of FIG. 2 when the moving member moves in a return direction;

FIG. 7 is a perspective view illustrating the rotating member and the one-direction rotating device when the moving member moves in the return direction; and

FIG. 8 is a sectional view illustrating an operational state of the rotating member when the moving member moves in the return direction.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

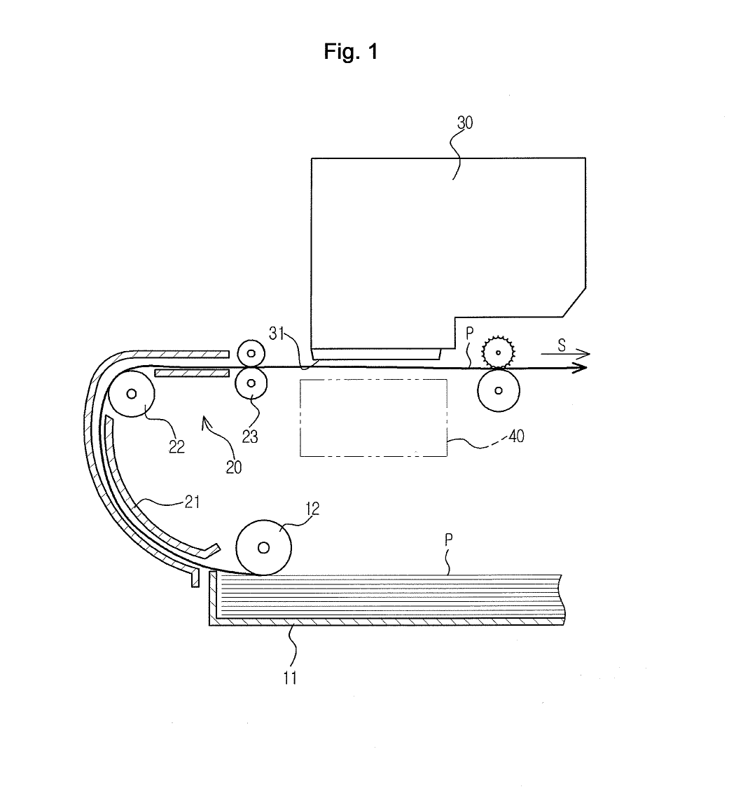

FIG. 1 is a view schematically illustrating an ink-jet image forming apparatus according to an embodiment of the present general inventive concept. As illustrated in FIG. 1, the ink-jet image forming apparatus includes a paper supply cassette 11 which stores paper P, a pickup roller 12 which picks up the paper, an ink-jet head 30 which prints an image, a feeding unit 20 which has a feeding guide part 21 and feeding rollers 22 and 23 to feed the paper P, and a cleaning device 40 which cleans a nozzle part 31 of the ink-jet head 30. The paper P picked up by the pickup roller 12 is fed in a sub-scanning direction S by the feeding unit 20. The ink-jet head 30 ejects an ink onto the paper P through the nozzle part 31, which is provided at a bottom of the ink-jet head 30, to print an image on the paper.

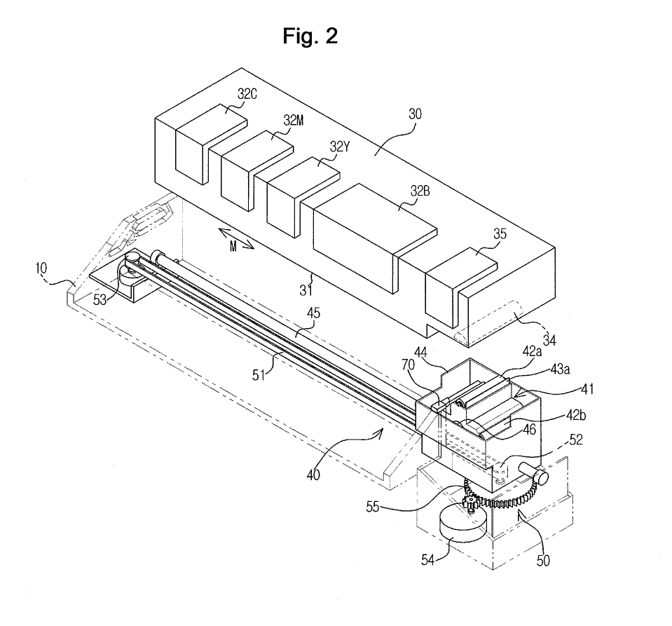

As illustrated in FIG. 2, the ink-jet head 30 is configured as an array type ink-jet head which is disposed in a lengthwise direction parallel to a main scanning direction M and is fixed to a main body 10 to form an image on the paper P in a stationary state with respect to the paper P. The nozzle part 31 has a length in the main scanning direction M to correspond to a width of the paper P, and is provided with a plurality of nozzles (not illustrated) to eject the ink therethrough. The ink-jet head 30 is further provided with a plurality of ink storage parts 32C, 32M, 32Y and 32B to supply the ink of different colors (e.g., cyan, magenta, yellow and black) to the nozzle part 31. Although they are not illustrated in the drawings, the respective ink storage parts 32C, 32M, 32Y and 32B communicate with the nozzle part 31 through an internal ink passage, and an ink chamber, which is provided with an ejection unit (e.g., a piezo element, a heater, etc) to generate an ink ejection pressure, is provided in the nozzle part 31. Because such a constitution is well known to a person skilled in the art, the more detailed explanation will be omitted.

An ink drop, which is not ejected, may be solidified or a foreign substance such as a dust may be attached to the nozzle part 31 of the ink-jet head 30. The cleaning device 40 cleans the surface of the nozzle part 31 to keep the nozzle part 31 in an optimum condition.

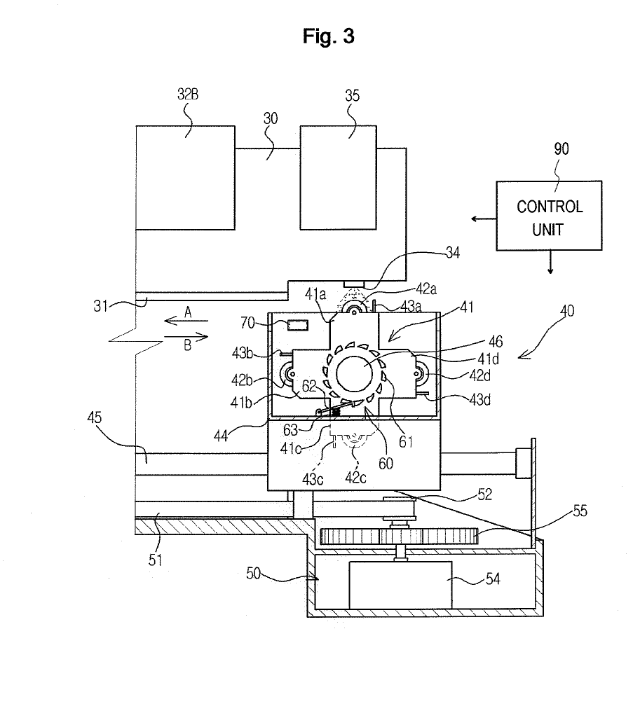

As illustrated in FIGS. 2 and 3, the cleaning device 40 includes a rotating member 41 to which a plurality of rollers 42a, 42b, 42c and 42d and a plurality of wipers 43a, 43b, 43c and 43d are mounted to clean the nozzle part 31, a moving member 44 which supports the rotating member 41, a guide member 45 which guides the movement of the moving member 44, and a driving device 50 which moves the moving member 44. The guide member 45 may be disposed on the main body 10 of the image forming apparatus or a frame of the clean device 40 to guide the moving member to move along the main scanning direction M parallel to the lengthwise direction of the ink-jet head 30.

The moving member 44 is formed in a rectangular box shape which has an opening at a top thereof. The guide member 45 is formed in a long rod shape and is disposed parallel with the nozzle part 31 below the nozzle part 31 in the lengthwise direction thereof. The guide member 45 supports the moving member 44 and at the same time guides the reciprocating movement of the moving member 44 below the nozzle part 31. The guide member 45 may have a length longer than the nozzle part 31.

The driving device 50 includes a driving belt 51, a driving pulley 52 and a driven pulley 53 which support the driving belt 51 so that the driving belt 51 travels over a path extending between the driving pulley 52 and the driven pulley 53, and a driving motor 54 which rotates the driving pulley 52 in a forward direction or in a reverse direction. As illustrated in FIG. 2, the driving belt 51 is disposed parallel with the guide member 45, and a portion of the driving belt 51 is connected to the moving member 44. The driving motor 54 is connected to the driving pulley 52 through a plurality of reduction gears 55. Accordingly, when the driving belt 51 circulates in the forward direction and in the reverse direction by the operation of the driving motor 54, the moving member 44 moves reciprocatingly along the guide member 45 below the nozzle part 31.

The rotating member 41 is rotatably mounted in the moving member 44 by a rotating shaft 46. The rotating member 41 is provided with a plurality of roller supporting portions 41a, 41b, 41c and 41d which extend outwardly and radially from a rotational center of the rotating member 41. The rollers 42a, 42b, 42c and 42d are respectively mounted to the roller supporting portions 41a, 41b, 41c and 41d to supply a cleaning liquid to the surface of the nozzle part 31 when the moving member 44 moves along the nozzle part 31. The wipers 43a, 43b, 43c and 43d are also mounted to the roller supporting portions 41a, 41b, 41c and 41d to wipe the surface of the nozzle part 31. The rollers 42a, 42b, 42c and 42d have a surface made of a porous absorbing material, such as a fiber or a sponge, so as to absorb the cleaning liquid supplied from a cleaning liquid nozzle 34 (which will be described later). The wipers 43a, 43b, 43c and 43d are respectively disposed at the rear of the rollers 42a, 42b, 42c and 42d with respect to a cleaning direction in which the moving member 44 moves to clean the nozzle part 31. Accordingly, after the cleaning liquid is supplied to the nozzle part 31 from the rollers 42a, 42b, 42c and 42d, the wipers 43a, 43b, 43c and 43d wipe a surface of the nozzle part 31. The wipers 43a, 43b, 43c and 43d are made of an elastic material such as a rubber material.

The ink-jet head 30 is provided with the cleaning liquid nozzle 34 to supply the cleaning liquid to the rollers 42a, 42b, 42c and 42d, and a cleaning liquid storage part 35 to store the cleaning liquid to be supplied to the cleaning liquid nozzle 34. As illustrated in FIGS. 2 and 3, when the moving member 44 is located at a stop position above the driving motor 54 after the cleaning operation is terminated, the cleaning liquid nozzle 34 supplies the cleaning liquid to the rollers 42a, 42b, 42c and 42d. The cleaning liquid nozzle 34 is provided at the bottom of the ink-jet head 30, and is disposed near one end of the nozzle part 31. If the moving member 44 moves to the stop position, the cleaning liquid nozzle 34 is aligned with the rollers 42a, 42b, 42c and 42d, so that the cleaning liquid can be supplied to the rollers 42a, 42b, 42c and 42d from the cleaning liquid nozzle 34.

Although they are not illustrated in the drawings, the ink-jet head 30 is provided with a passage to supply the cleaning liquid to the cleaning liquid nozzle 34 from the cleaning liquid storage part 35, and an ejection unit (e.g., a piezo element, etc.) to eject the cleaning liquid through the cleaning liquid nozzle 34. Because the cleaning liquid nozzle 34 and the cleaning liquid storage part 35 are integrally provided in the ink-jet head 30, when the ink is totally exhausted and the ink-jet head 30 is replaced, the cleaning liquid nozzle 34 and the cleaning liquid storage part 35 may be replaced together. Accordingly, because a separate work of replacing the cleaning liquid container for the supplement of the cleaning liquid is unnecessary, the image forming apparatus of this embodiment has a merit of easy maintenance. Also, because the cleaning liquid storage part 35 is integrally provided in the ink-jet head 30, a unit to supply the cleaning liquid can be simplified in comparison with a conventional apparatus. This results in the simplification of the constitution and the decrease in the bulk of the ink-jet image forming apparatus. Further, because the cleaning liquid is supplied to the rollers 42a, 42b, 42c and 42d in an ejection manner only when the cleaning operation is carried on, the consumption of the cleaning liquid can be reduced.

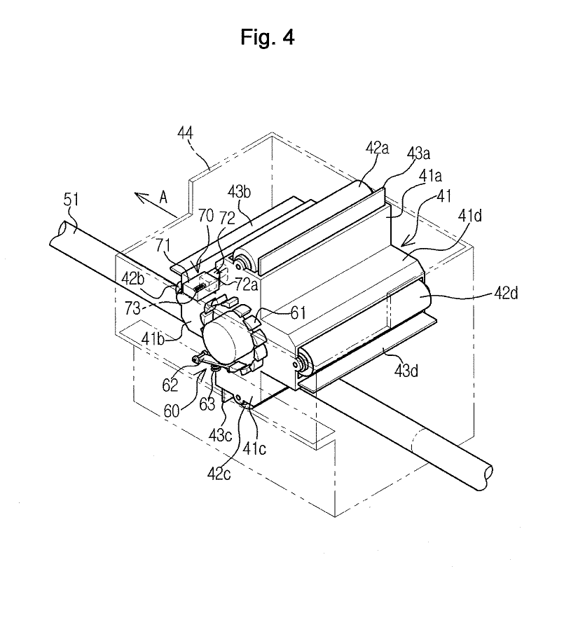

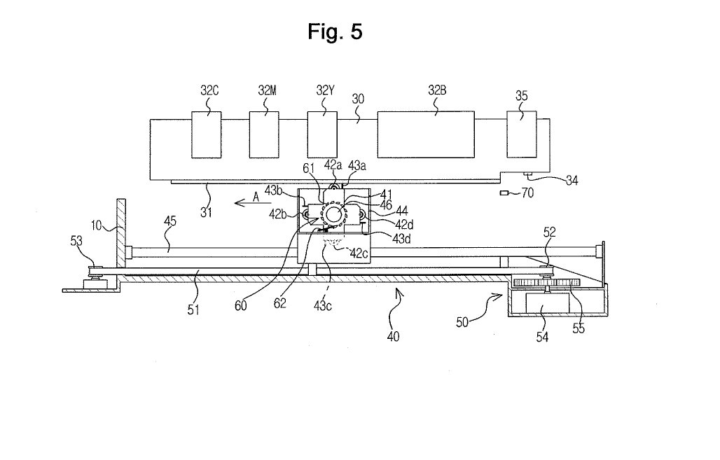

As illustrated in FIGS. 3 and 4, a one-direction rotating device 60 is mounted in the moving member 44. When the moving member 44 moves in the direction of cleaning the nozzle part 31 from the stop position, the one-direction rotating device 60 limits the rotation of the rotating member 41. When the moving member 44 returns to the stop position, the one-direction rotating device 60 allows the rotation of the rotating member 41. The one-direction rotating device 60 includes a ratchet 61 which is provided on a side surface of the rotating member 41, a stopper 62 which is mounted in the moving member 44 and is latched by the ratchet 61, and a spring 63 which biases the stopper 62 toward the ratchet 61. The one-direction rotating device 60 limits (or prevents) the rotation in the clockwise direction of the rotating member 41, and permits the rotation in the counterclockwise direction of the rotating member 41. Accordingly, as illustrated in FIG. 5, because the rotating member 41 does not rotate when the moving member 44 moves in the cleaning direction A, the roller 42a and the wiper 43a clean the nozzle part 31 while contacting the nozzle part 31.

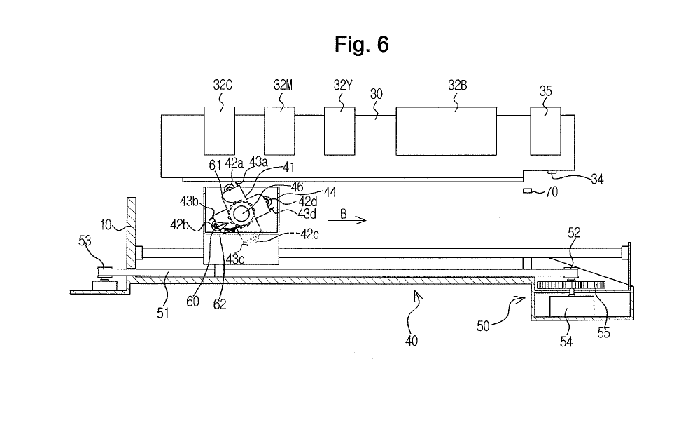

As illustrated in FIG. 6, when the moving member 44 moves in a return direction opposite to the cleaning direction toward the stop position, the rotating member 41 rotates slightly in the counterclockwise direction such that the roller 42a and the wiper 43a are separated from the nozzle part 31. When nozzles of the nozzle part 31 are cleaned by the cleaning device 40, a control unit 90 controls the driving motor 54 to change the moving direction of the moving member 44 from the cleaning direction to the return direction. When the moving member 44 is changed from the cleaning direction to the return direction, a friction between the nozzle part 31 and the cleaning device 40 can be applied to at least one of the roller 42a and the wiper 43a. The friction may be sufficient for the stopper 62 to release at least one of the ratchets 61 such that the cleaning device 40 is spaced-apart from the nozzle part 31, the rotating member 41 rotates by a predetermined angle in the clockwise direction, and/or the cleaning device 40 is not interfered with the nozzle part 31 when the cleaning device 40 moves in the return direction.

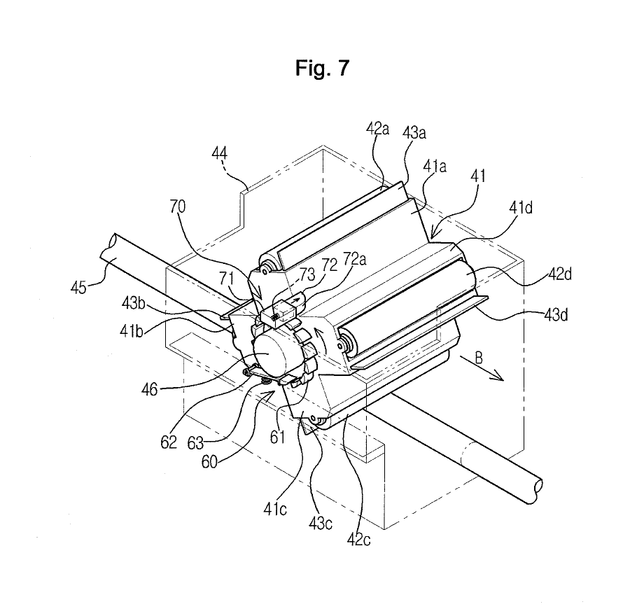

As illustrated in FIGS. 2 and 7, a latching device 70 is provided in the main body 10, correspondingly to the stop position of the moving member 44 (above the driving motor). When the moving member 44 returns to the stop position, the roller supporting portion 41a of the rotating member 41 is latched by the latching device 70. The rotating member 41 is restricted to rotate at a predetermined angle by the latching device 70, by which the roller supporting portion 41a is latched when the moving member 44 returns. In this embodiment, because the roller supporting portions 41a, 41b, 41c and 41d are spaced at substantially 90 degrees, the latching device 70 restricts the rotation of the rotating member 41 to 90 degrees. Accordingly, when the moving member 44 returns, the rotating member 41 rotates at 90 degrees, so that the roller 42a and the wiper 43a which have already performed the cleaning operation move downward, and the new roller 42d and wiper 43d move upward to perform the next cleaning operation.

As illustrated in FIGS. 4 and 7, the latching device 70 includes a case part 71 which is fixed to the main body 10, a latching part 72 which is slidably mounted in the case part 71 and protrudes toward the roller supporting portion 41a, and a spring 73 which is mounted in the case part 71 to bias the latching part 72 in the protruding direction. The latching part 72 is formed with a curved portion 72a at one end portion which contacts the rotating member 41. As illustrated in FIG. 4, if the roller supporting portions 41a, 41b, 41c and 41d contact the curved portion 72a and are latched thereby when the rotating member 41 moves in the cleaning direction A, the curved portion 72a guides the latching part 72 to slide into the case part 71. Accordingly, when the rotating member 41 moves in the cleaning direction, the rotating member 41 can pass by the latching device 70 without rotating. In other words, the latching device 70 allows the rotating member 41, which is limited in rotation, to move in the cleaning direction A.

Hereinafter, an operation of cleaning the nozzle part 31 in the ink-jet image forming apparatus will be described with reference to FIGS. 1-8.

After the printing operation, the cleaning operation is carried on to remove contaminants such as ink remnants from the nozzle part 31. As illustrated in FIG. 3, when performing the cleaning operation, a predetermined amount of cleaning liquid is ejected to the roller 42a which is located at the uppermost position from the cleaning liquid nozzle 34 provided in the ink-jet head 30. At this time, the cleaning liquid is ejected enough to get the roller 42a completely wet.

After the cleaning liquid is ejected to the roller 42a, the moving member 44 moves in the cleaning direction A by the operation of the driving device 50. At this time, the rotation of the rotating member 41 is limited or prevented. As illustrated in FIG. 4, the latching device 70 operates such that the latching part 72 comes into contact with the roller supporting portion 41a of the rotating member 41, and slides into the case part 71. Thus, the rotating member 41 passes by the latching device 70 with a minimum resistance. As illustrated in FIG. 5, when the moving member 44 moves in the cleaning device A, the roller 42a contacts the nozzle part 31, and thus the cleaning liquid supplied to the roller 42a wets the surface of the nozzle part 31. Accordingly, the foreign substances or the ink remnants on the nozzle part 31 become in an easily removable state. The wiper 43a cleans the surface of the nozzle part 31 by wiping off the foreign substances or the ink remnants from the nozzle part 31. Such an operation is continued while the moving member 44 moves from the position corresponding to the cleaning liquid nozzle 34 (the stop position) to the opposite position.

As illustrated in FIG. 6, after completely cleaning the nozzle part 31, the moving member 44 moves in the return direction B by the reverse operation of the driving device 50. Simultaneously with the start of the returning operation, a rotational force is applied to the rotating member 41 by the contact of the wiper 43a and the nozzle part 31, and thus the rotating member 41 rotates slightly in the counterclockwise direction. The rotational force may be greater than a force between the stopper 62 and the ratchet 61. Accordingly, while the returning operation is performed, since the roller 42a and the wiper 43a do not contact the nozzle part 31, the surface of the nozzle part 31 is maintained in a cleaned state, and a meniscus of the ink in a plurality of nozzles (not illustrated) is maintained. As a result, the ink is ready to be ejected smoothly in the next printing operation.

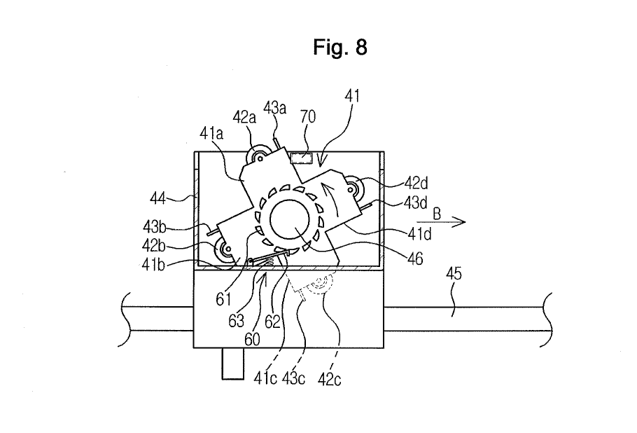

As illustrated in FIGS. 7 and 8, when the returning operation is nearly terminated, the rotating member 41 rotates by the roller supporting portion 41a of the rotating member 41 being latched by the latching device 70. So, the roller 42a and the wiper 43a which have already performed the cleaning operation move downward, and the new roller 42d and wiper 43d move upward. When the moving member 44 moves completely to the stop position, the new roller 42d is located below the cleaning liquid nozzle 34. Thus, the new roller 42d and wiper 43d are used in the next cleaning operation.

If the rotating member 41 rotates as described above, the roller 42a and the wiper 43a which have already performed the cleaning operation are not used until they are again used in the cleaning operation. Thus, drying time of the roller 42a and the wiper 43a can be sufficiently secured. Since the sufficiently dried roller 42a can absorb enough cleaning liquid when performing the cleaning operation, the cleaning effect of the nozzle part 31 can be increased. Further, since the foreign substances attached to the roller 42a or the wiper 43a during the previous cleaning operation are sufficiently dried, the contamination of the nozzle part 31 due to the foreign substances attached to the roller 42a or the wiper 43a can be minimized when the following cleaning operation is carried on. This embodiment describes that four rollers 42a, 42b, 42c and 42d and four wipers 43a, 43b, 43c and 43d are used by turns. However, the number of rollers and wipers is not limited thereto. The number of rollers and wipers may be respectively two, three, five or more.

If the ink in the ink-jet head 30 is totally exhausted, the ink-jet head 30 is replaced. Because the cleaning liquid nozzle 34 and the cleaning liquid storage part 35 are integrally provided in the ink-jet head 30, the cleaning liquid nozzle 34 and the cleaning liquid storage part 35 are replaced together.

As apparent from the above description, the ink-jet image forming apparatus according to the present general inventive concept can more simplify the cleaning liquid supply unit than a conventional unit, because the cleaning liquid nozzle and the cleaning liquid storage part are integrally provided in the ink-jet head.

Further, because a predetermined amount of cleaning liquid is supplied to the rollers in an ejection manner from the cleaning liquid nozzle, the consumption of the cleaning liquid can be minimized.

Further, because the cleaning liquid nozzle and the cleaning liquid storage part are integrally provided in the ink-jet head, the cleaning liquid nozzle and the cleaning liquid storage part can be replaced together when the ink-jet head is replaced. Accordingly, the maintenance of the apparatus can be easily achieved.

Further, because the cleaning liquid nozzle and the cleaning liquid storage part are integrally provided in the ink-jet head, the constitution of the ink-jet image forming apparatus can be more simplified and the bulk can be more decreased than a prior art.

Still further, because the plural rollers and wipers to clean the nozzle part are used by turns, the sufficiently dried rollers and wipers can be used in cleaning the nozzle part. Accordingly, since the rollers gets wet through with the cleaning liquid, the cleaning effect of the nozzle part can be increased, and the contamination of the nozzle part due to the rollers or the wipers can be minimized.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink-jet image forming apparatus comprising:
a main body;
an ink-jet head mounted in the main body and provided with a nozzle part; and
a cleaning device mounted movably along the nozzle part to clean the nozzle part,
wherein the cleaning device includes a roller to supply a cleaning liquid to the nozzle part, and a wiper to wipe the nozzle part, and
the ink-jet head includes a cleaning liquid nozzle to supply the cleaning liquid to the roller, and a cleaning liquid storage part to store the cleaning liquid.

2. The ink-jet image forming apparatus of claim 1, wherein the cleaning liquid nozzle and the cleaning liquid storage part are integrally provided in the ink-jet head.

3. The ink-jet image forming apparatus of claim 1, wherein:
the nozzle part has a length in a main scanning direction corresponding to a width of paper; and
the cleaning device includes a moving member to support the roller and the wiper and to move in a longitudinal direction of the nozzle part, a guide member to guide the movement of the moving member, and a driving device to move the moving member.

4. The ink-jet image forming apparatus of claim 3, wherein:
the cleaning liquid nozzle is disposed near one end of the nozzle part; and
during a non-cleaning state, the moving member moves to a stop position adjacent to the cleaning liquid nozzle so that the roller is located corresponding to the cleaning liquid nozzle.

5. The ink-jet image forming apparatus of claim 4, wherein:
the cleaning device includes a rotating member rotatably coupled to the moving member and having a plurality of roller supporting portions arranged in a radial direction of a rotation axis of the rotating member;
the roller includes a plurality of rollers respectively mounted to the roller supporting portions; and
the wiper includes a plurality of wipers respectively mounted to the roller supporting portions.

6. The ink-jet image forming apparatus of claim 5, wherein the cleaning device includes a one-direction rotating device which limits the rotation of the rotating member when the moving member moves in a cleaning direction from the stop position, and allows the rotation of the rotating member when the moving member returns to the stop position.

7. The ink-jet image forming apparatus of claim 6, wherein:
the cleaning device includes a latching device provided at the stop position; and
when the moving member returns to the stop position, the rotating member is latched by the latching device, and rotates at a predetermined angle.

8. The ink-jet image forming apparatus of claim 6, wherein the one-direction rotating device includes a ratchet provided at the rotating member, a stopper latched by the ratchet, and a spring to bias the stopper toward the ratchet.

9. The ink-jet image forming apparatus of claim 3, wherein the driving device includes a driving motor, and a driving belt which travels in a forward direction and in a reverse direction by the operation of the driving motor and moves the moving member in a cleaning direction and in a return direction.

10. The ink-jet image forming apparatus of claim 1, wherein the roller has a surface made of a porous absorbing material.

11. An ink-jet image forming apparatus comprising:
an ink-jet head provided with a nozzle part; and
a cleaning device mounted movably along the nozzle part to clean the nozzle part, wherein the ink-jet head includes a cleaning liquid nozzle to supply a cleaning liquid to the cleaning device, and a cleaning liquid storage part to store the cleaning liquid.

12. An ink-jet image forming apparatus comprising:
an ink-jet head provided with a nozzle part having a length in a main scanning direction corresponding to a width of paper; and
a cleaning device mounted movably along the nozzle part to clean the nozzle part,
wherein the cleaning device includes a moving member moving in a longitudinal direction of the nozzle part, a guide member to guide the movement of the moving member, a driving device to move the moving member, a rotating member rotatably coupled to the moving member and provided with plural roller supporting portions arranged radially, plural rollers respectively mounted to the roller supporting portions to supply a cleaning liquid to the nozzle part, plural wipers respectively mounted to the roller supporting portions, and a one-direction rotating device which limits the rotation of the rotating member when the moving member moves in a cleaning direction and allows the rotation of the rotating member at a predetermined angle when the moving member returns.

13. The ink-jet image forming apparatus of claim 12, wherein:
the cleaning device further includes a latching device; and
when the moving member returns, the rotating member is latched by the latching device and rotates.

14. An image forming apparatus comprising:
an ink-jet head having a nozzle part to eject ink, a cleaning nozzle part to eject a cleaning liquid to clean the nozzle part, and a cleaning device disposed to have a first distance with the nozzle part n a printing operation and to have a second distance with the nozzle part in a return operation.
